(19) United States
(12) Patent Application Publication
(10) Pub. No.: US 2023/0187689 A1
(43) Pub. Date: Jun. 15, 2023

(54) LITHIUM-ION BATTERY AND METHOD FOR MANUFACTURING THE SAME

(71) Applicant: TOYOTA JIDOSHA KABUSHIKI KAISHA, Toyota-shi (JP)

(72) Inventors: Mitsuru TATEISHI, Toyota-shi (JP); Hajime HASEGAWA, Aichi-gun (JP)

(73) Assignee: TOYOTA JIDOSHA KABUSHIKI KAISHA, Toyota-shi (JP)

(21) Appl. No.: 17/948,591

(22) Filed: Sep. 20, 2022

(30) Foreign Application Priority Data
Dec. 13, 2021 (JP) 2021-201517

(51) Int. Cl. H01M 10/0562; H01M 4/134; H01M 10/0525; H01M 4/04; H01M 4/38

(52) U.S. Cl. CPC H01M 10/0562; H01M 4/38; H01M 4/134; H01M 4/0402; H01M 10/0525; H01M 2004/027

(57) ABSTRACT

A lithium ion battery includes a positive electrode, a negative electrode, and an electrolyte. The positive electrode includes a positive electrode active material. The negative electrode includes a negative electrode active material and a specific metal. A void is located inside the negative electrode active material. The specific metal adheres to an outside surface and an inside surface of the negative electrode active material. The specific metal includes a dissolution potential and a deposition potential. The dissolution potential is lower than a potential at which the positive electrode active material releases Li ions. The deposition potential is higher than a potential at which the negative electrode active material stores the Li ions.

### CROSS-REFERENCE TO RELATED APPLICATION

This application claims priority to Japanese Patent Application No. 2021-201517 filed on Dec. 13, 2021, incorporated herein by reference in its entirety.

### BACKGROUND

### 1. Technical Field

The present disclosure relates to lithium-ion batteries and methods for manufacturing the same.

### 2. Description of Related Art

Japanese Unexamined Patent Application Publication No. 2013-246992 (JP 2013-246992 A) discloses that a negative electrode active material contains in its surface at least one selected from the group consisting of molybdenum (Mo), tungsten (W), aluminum (Al), zirconium (Zr), magnesium (Mg), titanium (Ti), and zinc (Zn).

### SUMMARY

It is known that, in lithium-ion batteries (hereinafter sometimes simply referred to as “batteries”), a film is formed at the interface between a negative electrode active material and an electrolyte. This film is referred to as a solid electrolyte interface (SEI). As the SEI grows thicker, the battery resistance increases.

One proposed method to inhibit the SEI growth is to cause a metal to adhere to the outside surface of the negative electrode active material. The battery resistance is expected to be reduced by inhibiting the SEI growth. However, there is still room for further improvement.

The present disclosure provides a lithium-ion battery with reduced battery resistance and a method for manufacturing the same.

Hereinafter, the technical configurations and functions and effects of the present disclosure will be described. However, the functional mechanism of the present specification includes estimation. The functional mechanism does not limit the technical scope of the present disclosure.

1. A lithium-ion battery according to one aspect of the present disclosure includes a positive electrode, a negative electrode, and an electrolyte. The positive electrode includes a positive electrode active material. The negative electrode includes a negative electrode active material and a specific metal. A void is located inside the negative electrode active material. The specific metal adheres to an outside surface and an inside surface of the negative electrode active material. The specific metal includes a dissolution potential and a deposition potential. The dissolution potential is lower than a potential at which the positive electrode active material releases lithium (Li) ions. The deposition potential is higher than a potential at which the negative electrode active material stores the Li ions.

The “specific metal” has a specific dissolution potential and a specific deposition potential. The dissolution potential is lower than the potential at which the positive electrode active material releases Li ions. The deposition potential is higher than the potential at which the negative electrode active material stores Li ions.

In related art, the specific metal is avoided from getting into the battery. This is because the specific metal dissolved in the positive electrode and deposited on the negative electrode can cause, for example, a micro short-circuit. According to the new findings of the present disclosure, the specific metal has an advantage that it can inhibit the SEI growth. The battery resistance is expected to be reduced by the specific metal adhering to the outside surface of the negative electrode active material.

However, there are cases where a void is located inside the negative electrode active material. That is, the negative electrode active material can include not only the outside surface but also the inside surface. The inside surface is a surface that faces the void inside the negative electrode active material. The inside surface is not exposed to the outside. SEI can grow on both the outside surface and the inside surface. Even when the specific metal adheres only to the outside surface, SEI may grow on the inside surface.

In the present disclosure, the specific metal adheres to both the outside and inside surfaces. Accordingly, the SEI growth can be inhibited on both the outside and inside surfaces. The battery resistance is expected to be further reduced as the SEI growth is also inhibited on the inside surface.

2. The specific metal may include, for example, at least one selected from the group consisting of potassium (K), rubidium (Rb), barium (Ba), strontium (Sr), calcium (Ca), sodium (Na), magnesium (Mg), aluminum (Al), uranium (U), titanium (Ti), zirconium (Zr), manganese (Mn), zinc (Zn), chromium (Cr), iron (Fe), cadmium (Cd), cobalt (Co), nickel (Ni), tin (Sn), lead (Pb), copper (Cu), mercury (Hg), and silver (Ag).

3. The specific metal may include, for example, at least one selected from the group consisting of Fe, Cr, and Ni.

4. A ratio of mass of the specific metal to mass of the negative electrode active material may be 0.192 to 0.384.

Hereinafter, the “ratio of the mass of the specific metal to the mass of the negative electrode active material” is sometimes simply referred to as the “mass ratio.” With the mass ratio being 0.192 or more, the resistance reducing effect is expected to be enhanced. With the mass ratio being 0.384 or less, the rate of occurrence of micro short-circuits can be reduced.

5. The negative electrode active material may be a secondary particle including a plurality of primary particles, and the void may be located between the primary particles.

6. In the negative electrode active material, the specific metal may adhere to the inside surface up to a distance of one-fifth or more of a maximum diameter of the secondary particle from a surface of the secondary particle toward a center of the secondary particle on a line segment of the maximum diameter of the secondary particle.

7. A method for manufacturing a lithium-ion battery according to one aspect of the present disclosure includes the following (a) to (e): (a) preparing a positive electrode including a positive electrode active material; (b) preparing a negative electrode including a negative electrode active material; (c) assembling the lithium-ion battery including the positive electrode, the negative electrode, an electrolyte, and a specific metal; (d) performing first charging of the lithium-ion battery; and (e) after the first charging, performing second charging of the lithium-ion battery. A void is located inside the negative electrode active material. The specific metal includes a dissolution potential and a deposition potential. The dissolution potential is lower than a potential at which the positive electrode active material releases Li ions. The deposition potential is higher than a potential at which the negative electrode active material stores the Li ions. In (c), the specific metal is placed so as to be electrically in contact with the positive electrode. The first charging includes performing constant voltage charging of the lithium-ion battery at such a battery voltage that a positive electrode potential becomes higher than the dissolution potential and a negative electrode potential becomes higher than the deposition potential. In the second charging, the negative electrode potential becomes equal to or lower than the deposition potential.

The battery of the above “1” can be manufactured by, for example, the manufacturing method of the above “7.” In the first charging, specific metal ions can be produced by oxidation and dissolution of the specific metal on the positive electrode side. The specific metal ions diffuse to the negative electrode side. In the first charging, the specific metal is less likely to be deposited as the negative electrode potential is higher than the deposition potential of the specific metal. Therefore, the specific metal ions can diffuse into the void inside the negative electrode active material. After the specific metal ions diffuse into the void inside the negative electrode active material, the second charging is performed so that the negative electrode potential becomes equal to or lower than the deposition potential. As a result, the specific metal can be deposited on both the outside and inside surfaces of the negative electrode active material.

Hereinafter, an embodiment of the present disclosure (hereinafter sometimes simply referred to as the “embodiment”) and examples of the present disclosure (hereinafter sometimes simply referred to as the “examples”) will be described. However, the embodiment and the examples are not intended to limit the technical scope of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a lithium-ion battery according to the embodiment;

FIG. 2 is a schematic view of an electrode assembly;

FIG. 3 is a schematic flowchart of a method for manufacturing a lithium-ion battery according to the embodiment;

FIG. 4 is a graph showing an example of first charging;

FIG. 5 is a graph showing battery resistance; and

FIG. 6 shows sectional scanning electron microscope (SEM) images of negative electrodes of No. 2 and No. 3.

### DETAILED DESCRIPTION OF EMBODIMENTS

### Definition of Terms Etc.

In the present specification, the terms “comprise,” “include,” “have,” and variations thereof (e.g., “composed of”) are open-ended. When any of the open-ended terms is used, it means that additional elements may or may not be included in addition to essential elements. The term “consist of” is closed-ended. However, even when the closed-ended term is used, it does not mean that additional elements such as normally accompanying impurities and elements irrelevant to the technique of the present disclosure are excluded. The term “substantially consist of” is semi-closed-ended. When the semi-closed-ended term is used, it means that it is allowed to add elements that do not substantially affect the basic and novel characteristics of the technique of the present disclosure.

In the present specification, the words such as “may” and “can” are used in a permissive sense, meaning that “it is possible,” rather than in a mandatory sense, meaning “must”.

In the present specification, the numerical ranges such as “m% to n%” include their upper and lower limit values unless otherwise specified. That is, “m% to n%” indicates the numerical range of “m% or more and n% or less.” Further, “m% or more and n% or less” includes “more than m% and less than n%.” A numerical value selected as desired from the numerical range may be set as a new upper limit value or a new lower limit value. For example, a new numerical range may be set by combining a numerical value in the numerical range and a numerical value shown in a different part of the present specification, in a table, in the drawings, etc.

In the present specification, all numerical values should be interpreted as having the term “about” in front of them. The term “about” can mean, for example, ±5%, ±3%, or ±1%. All numerical values can be approximate values that can vary depending on the manner in which the technique of the present disclosure is used. All numerical values can be expressed in significant figures. A measured value can be an average value of a plurality of measurements. The number of measurements may be three or more, five or more, or ten or more. It is generally expected that the larger the number of measurements, the higher the reliability of the average value. A measured value can be rounded based on the number of significant figures. A measured value can include an error etc. due to, for example, the detection limit of a measuring device.

In the present specification, when a compound is represented by a stoichiometric composition formula (e.g., “LiCoO₂”), the stoichiometric composition formula is merely a representative example of the compound. The compound may have a non-stoichiometric composition. For example, when lithium cobalt oxide is represented by “LiCoO₂,” lithium cobalt oxide is not limited to the composition ratio of “Li/Co/O = 1/1/2” and can contain lithium (Li), cobalt (Co), and oxygen (O) at any composition ratio, unless otherwise specified. Moreover, doping with a trace element, substitution of a trace element, etc. can be allowed.

In the present disclosure, the order in which a plurality of steps, actions, operations, etc. included in various methods is performed is not limited to the described order unless otherwise specified. For example, a plurality of steps may proceed in parallel. For example, the order of a plurality of steps may be reversed.

As used herein, “D50” indicates a particle size at which the cumulative frequency in order from the smallest particle size reaches 50% in a volume-based particle size distribution.

The “void ratio” as used herein can be measured in sectional images of a negative electrode active material. Sectional images can be acquired by a Scanning Electron Microscope (SEM). By binarizing a sectional image, a tangible portion and a void portion are distinguished from each other. The area of the tangible portion and the area of the void portion in the sectional image are measured. The void ratio is obtained by the following expression (I).

$$φ = {\text{S}}_{2} \div \left({\text{S}}_{1} + {\text{S}}_{2}\right) \times 100$$

φ represents the void ratio (%).
S₁ represents the area of the tangible portion.
S₂ represents the area of the void portion.

As used herein, the “outside surface” refers to the outer surface of an object. The “inside surface” refers to a surface that faces a void inside an object.

As used herein, “electrically in contact” means that two objects are in direct or indirect contact with each other and therefore the two objects have an equal potential.

In the present specification, the magnitude of the hour rate of a current may be represented by the symbol “C.” A current of 1 C discharges the rated battery capacity in one hour.

As used herein, the “state of charge (SOC)” is defined as the percentage of the remaining capacity to the full charge capacity.

As used herein, the “ambient temperature” indicates the temperature of the environment surrounding an object. For example, when a battery (object) is located in a constant temperature bath, the set temperature of the constant temperature bath can be regarded as an ambient temperature.

### Lithium-Ion Battery

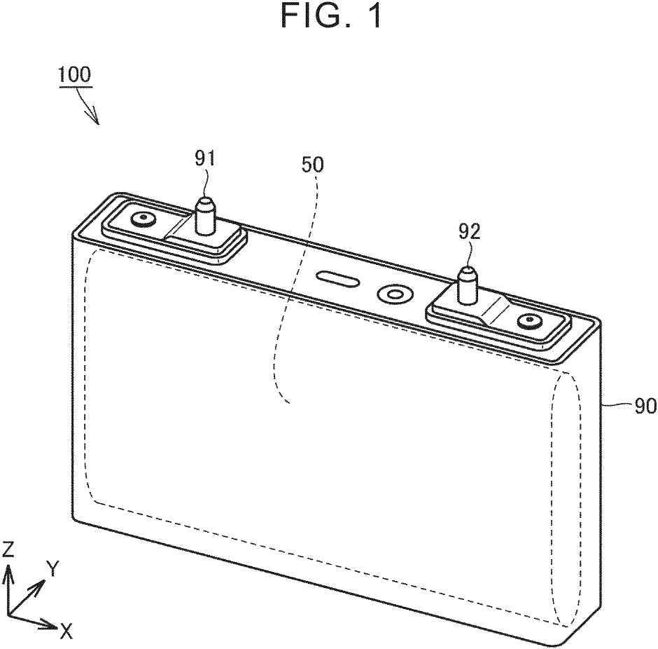

FIG. 1 is a schematic view of a lithium-ion battery according to the embodiment. Hereinafter, the “lithium-ion battery according to the embodiment” is sometimes simply referred to as the “battery.” A battery 100 includes a case 90. The case 90 may be made of, for example, metal. The case 90 can be in any form. The case 90 may have a rectangular shape (rectangular parallelepiped shape, flat rectangular parallelepiped shape) or a cylindrical shape. The case 90 may be, for example, a pouch made of an aluminum (Al) laminated film. The case 90 may be provided with a positive electrode terminal 91 and a negative electrode terminal 92.

The case 90 encloses an electrode assembly 50 and an electrolyte. The electrode assembly 50 is impregnated with the electrolyte. A part of the electrolyte may be stored at the bottom of the case 90. The electrode assembly 50 is connected to the positive electrode terminal 91 and the negative electrode terminal 92.

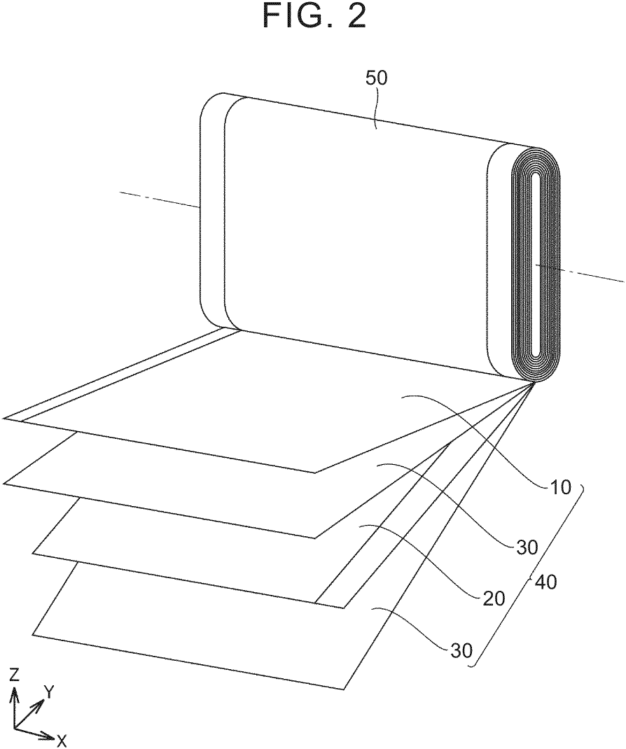

FIG. 2 is a schematic view of the electrode assembly 50. The electrode assembly 50 includes a positive electrode 10, a separator 30, and a negative electrode 20. The electrode assembly 50 can have any desired structure. The electrode assembly 50 may be, for example, a wound electrode assembly. The electrode assembly 50 may include, for example, a stack 40. The stack 40 is formed by stacking a positive electrode 10, a separator 30 (first separator), a negative electrode 20, and a separator 30 (second separator) in this order. The electrode assembly 50 is formed by winding the stack 40 in a spiral. After the winding, the electrode assembly 50 may be formed into a flat shape.

### Positive Electrode

The positive electrode 10 may be, for example, a strip-shaped sheet. The positive electrode 10 may include a positive electrode current collector and a positive electrode active material layer. The positive electrode current collector may include, for example, Al foil etc. The positive electrode active material layer may be located on a surface of the positive electrode current collector. The positive electrode active material layer may be located on only one side of the positive electrode current collector, or may be located on both front and back sides of the positive electrode current collector. The positive electrode active material layer contains a positive electrode active material. The positive electrode active material layer may further contain, for example, an electrically conductive material, a binder, etc.

The positive electrode active material may be, for example, in the form of particles. The positive electrode active material may have, for example, a D50 of 1 µm to 30 µm.

The positive electrode active material can release Li ions at a release potential. The release potential is also referred to as the reaction potential. The release potential may be, for example, 3.0 Vvs. Li/Li⁺ or more, 3.2 Vvs. Li/Li⁺ or more, or 3.4 Vvs. Li/Li⁺ or more. The release potential may be, for example, 3.5 Vvs. Li/Li⁺ to 4.5 Vvs. Li/Li⁺. “Vvs. Li/Li⁺” indicates a potential relative to the redox potential of Li when the redox potential of Li is considered to be a reference (zero).

The positive electrode active material may include, for example, at least one selected from the group consisting of LiCoO₂, LiNiO₂, LiMnO₂, LiMn₂O₄, Li(NiCoMn)O₂, Li(NiCoAl)O₂, and LiFePO₄. For example, “(NiCoMn)” in “Li(NiCoMn)O₂” indicates that the total composition ratio inside the parentheses is 1. The amounts of individual components can be as desired, as long as the total is 1. Li(NiCoMn)O₂ may include, for example, Li(Ni_{⅓}Co_{⅓}Mn_{⅓})O₂, Li(Ni₀.5Co_{0.2}Mn_{0.3})O₂, and Li(Ni_{0.8}Co_{0.1}Mn_{0.1})O₂.

The electrically conductive material may include, for example, carbon black. For example, 0.1 parts by mass to 10 parts by mass of the electrically conductive material may be added per 100 parts by mass of the positive electrode active material. The binder may include, for example, polyvinylidene difluoride (PVDF). For example, 0.1 parts by mass to 10 parts by mass of the binder may be added per 100 parts by mass of the positive electrode active material.

### Negative Electrode

The negative electrode 20 may be, for example, a strip-shaped sheet. The negative electrode 20 may include a negative electrode current collector and a negative electrode active material layer. The negative electrode current collector may include, for example, Cu foil etc. The negative electrode active material layer may be located on a surface of the negative electrode current collector. The negative electrode active material layer may be located on only one side of the negative electrode current collector, or may be located on both front and back sides of the negative electrode current collector. The negative electrode active material layer contains a negative electrode active material and a specific metal. The negative electrode active material layer may further contain, for example, an electrically conductive material, a binder, etc.

The negative electrode active material may be, for example, in the form of particles. The negative electrode active material may have, for example, a D50 of 1 µm to 30 µm.

The negative electrode active material stores Li ions at a storage potential. The storage potential is also referred to as the “reaction potential.” The storage potential may be, for example, 2.0 Vvs. Li/Li⁺ or less, 1.0 Vvs. Li/Li⁺ or less, or 0.5 Vvs. Li/Li⁺ or less. The storage potential may be, for example, 0 Vvs. Li/Li⁺ to 0.3 Vvs. Li/Li⁺.

The negative electrode active material may include, for example, at least one selected from the group consisting of graphite, soft carbon, hard carbon, silicon (Si), silicon oxide, silicon alloys, tin (Sn), tin oxide, tin alloys, and Li₄Ti₅O₁₂.

Voids are located inside the negative electrode active material. The negative electrode active material may be, for example, hollow particles. The negative electrode active material may be, for example, secondary particles. A secondary particle includes a plurality of primary particles. The voids may be located between primary particles. The negative electrode active material may include, for example, spheroidal graphite. Spheroidal graphite is secondary particles. Spheroidal graphite includes a plurality of scales (primary particles). Voids can be located between the scales. The negative electrode active material may have, for example, a void ratio of 5% to 70% or a void ratio of 10% to 50%.

The specific metal adheres to the outside surface and inside surface of the negative electrode active material. The specific metal can inhibit the SEI growth. The specific metal has a dissolution potential and a deposition potential. The specific metal can be dissolved in the electrolyte at the dissolution potential. The specific metal dissolved in the electrolyte can be deposited at the deposition potential. The dissolution potential is lower than the release potential (reaction potential) of the positive electrode active material. The deposition potential is higher than the storage potential (reaction potential) of the negative electrode active material.

The difference between the dissolution potential of the specific metal and the release potential of the positive electrode active material may be, for example, 0.01 V or more, or 0.1 V or more. The difference between the dissolution potential of the specific metal and the release potential of the positive electrode active material may be, for example, 0.3 V or less.

The difference between the deposition potential of the specific metal and the storage potential of the negative electrode active material may be, for example, 0.01 V or more, or 0.1 V or more. The difference between the deposition potential of the specific metal and the storage potential of the negative electrode active material may be, for example, 0.3 V or less.

The specific metal may penetrate deeply into the negative electrode active material. For example, the maximum diameter (d) of the negative electrode active material (particles) is measured in a sectional image of the negative electrode active material. The specific metal may adhere to the inside surface that is located at a distance of ⅕d or more from the surface of the particle toward the center of the particle on a line segment of the maximum diameter. The specific metal may adhere to the inside surface that is located at a distance of ⅖d or more from the surface of the particle toward the center of the particle on the line segment of the maximum diameter.

The specific metal may cover 10% to 100% of the inside surface, 30% to 100% of the inside surface, 50% to 100% of the inside surface, or 70% to 100% of the inside surface. The coverage of the inside surface can be measured by the following procedure. The total length of the outlines of the voids is measured in a sectional image of the negative electrode active material. The total of the lengths of the specific metal (curve) adhering to the inside surface is measured in the same sectional image. The coverage of the inside surface is obtained by the following expression (II).

$$θ = {σ}_{2} \div {σ}_{1} \times 100$$

θ represents the coverage (%) of the inside surface.
σ₁ represents the total length of the outlines of the voids.
σ₂ represents the total of the lengths of the specific metal. The length of the specific metal indicates the length of the specific metal facing with a void.

The specific metal may form, for example, a compound. The specific metal may form, for example, a solid solution. The specific metal may form, for example, an intermetallic compound. The specific metal may form, for example, an oxide. The specific metal may be, for example, an alloy. The specific metal may be, for example, a simple substance. With the specific metal being a single substance or an alloy or forming an intermetallic compound, the resistance reducing effect is expected to be enhanced.

The specific metal may include, for example, at least one selected from the group consisting of K, Rb, Ba, Sr, Ca, Na, Mg, Al, U, Ti, Zr, Mn, Zn, Cr, Fe, Cd, Co, Ni, Sn, Pb, Cu, Hg, and Ag.

The specific metal may include, for example, at least one selected from the group consisting of Fe, Cr, and Ni. Fe, Cr, and Ni are constituent elements of SUS304. SUS304 is widely used in battery manufacturing equipment. In related art, it is considered that, for example, a small piece of SUS304 getting into a battery due to wear of battery manufacturing equipment causes a micro short-circuit. Therefore, a battery is usually manufactured so that small pieces of SUS304, Fe, Cr, and Ni, etc. do not get into the battery. According to the new findings of the present disclosure, Fe, Cr, and Ni have an advantage that they can inhibit the SEI growth. The dissolution potential of SUS304 can be 3.5 Vvs. Li/Li⁺. The deposition potential of SUS304 can be 1.9 Vvs. Li/Li⁺.

The ratio of the mass of the specific metal to the mass of the negative electrode active material (mass ratio) may be, for example, 0.192 to 0.384. With the mass ratio being 0.192 or more, the resistance reducing effect is expected to be enhanced. With the mass ratio being 0.384 or less, the rate of occurrence of micro short-circuits can be reduced. For example, the mass fraction of the negative electrode active material and the mass fraction of the specific metal can be measured by performing energy dispersive X-ray spectroscopy (EDX) on a sectional SEM image of the negative electrode active material layer. The mass ratio is obtained by dividing the mass fraction of the specific metal by the mass fraction of the negative electrode active material.

The electrically conductive material may include, for example, a carbon nanotube (CNT). For example, 0.1 parts by mass to 10 parts by mass of the electrically conductive material may be added per 100 parts by mass of the negative electrode active material. The binder may include, for example, carboxymethyl cellulose (CMC) or styrene butadiene rubber (SBR). For example, 0.1 parts by mass to 10 parts by mass of the binder may be added per 100 parts by mass of the negative electrode active material.

### Separator

The separator 30 may be, for example, a strip-shaped film. The separator 30 is porous. The separator 30 can allow the electrolyte to permeate it. The separator 30 separates the positive electrode 10 and the negative electrode 20. The separator 30 is electrically insulating. The separator 30 may include, for example, a polyolefin resin. The polyolefin resin may include, for example, at least one selected from the group consisting of polyethylene (PE) and polypropylene (PP). The separator 30 may have, for example, a single-layer structure. The separator 30 may be substantially composed of, for example, a PE layer. The separator 30 may have, for example, a multilayer structure. The separator may be formed by, for example, stacking a PP layer, a PE layer, and a PP layer in this order. For example, a heat-resistant layer (ceramic particle layer) may be formed on the surface of the separator 30.

### Electrolyte

The electrolyte contains a solvent and a Li salt. The solvent is aprotic. The solvent can contain any desired component. The solvent may contain, for example, at least one selected from the group consisting of ethylene carbonate (EC), propylene carbonate (PC), butylene carbonate (BC), dimethyl carbonate (DMC), ethyl methyl carbonate (EMC), diethyl carbonate (DEC), 1,2-dimethoxyethane (DME), methyl formate (MF), methyl acetate (MA), methyl propionate (MP), and γ-butyrolactone (GBL).

The Li salt is a supporting electrolyte. The Li salt is dissolved in the solvent. The Li salt may include, for example, at least one selected from the group consisting of LiPF₆, LiBF₄, and LiN(FSO₂)₂. The Li salt may have a molar concentration of, for example, 0.5 mol/L to 2.0 mol/L, or 0.8 mol/L to 1.2 mol/L.

The electrolyte may further contain any desired additive in addition to the solvent and the Li salt. For example, the electrolyte may contain an additive with a mass fraction of 0.01% to 5%. The additive may include, for example, at least one selected from the group consisting of vinylene carbonate (VC), vinyl ethylene carbonate (VEC), etc.

### Method for Manufacturing Lithium-Ion Battery

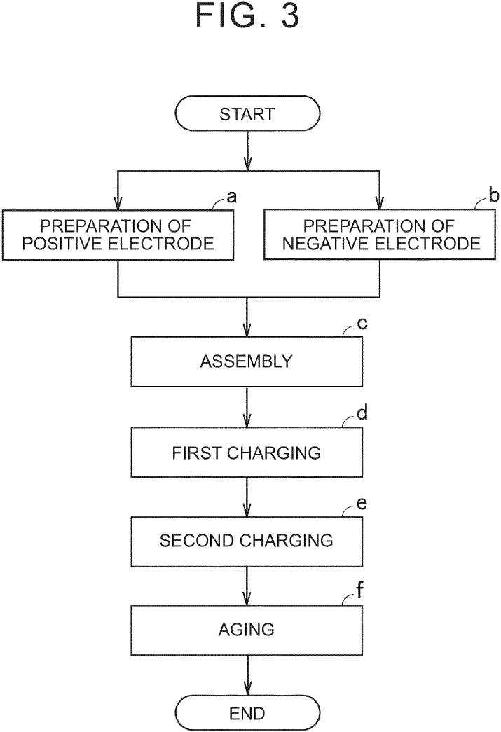

FIG. 3 is a schematic flowchart of a method for manufacturing a lithium-ion battery according to the embodiment. Hereinafter, the “method for manufacturing a lithium-ion battery according to the embodiment” is sometimes simply referred to as the “manufacturing method.” The manufacturing method includes “(a) preparation of positive electrode,” “(b) preparation of negative electrode,” “(c) assembly,” “(d) first charging,” and “(e) second charging.” The manufacturing method may further include, for example, “(f) aging”.

### (A) Preparation of Positive Electrode

The manufacturing method includes preparing the positive electrode 10 including a positive electrode active material. For example, a positive electrode active material layer may be formed by applying a slurry containing the positive electrode active material to a surface of a positive electrode current collector.

In the manufacturing method, the specific metal is placed so as to be electrically in contact with the positive electrode 10. The specific metal may be added to the positive electrode 10 in advance. For example, powder of the specific metal may be added to the slurry. For example, a small piece of the specific metal may be placed on a surface of the positive electrode active material layer.

### (B) Preparation of Negative Electrode

The manufacturing method includes preparing the negative electrode 20 including a negative electrode active material. For example, a negative electrode active material layer may be formed by applying a slurry containing the negative electrode active material to a surface of a negative electrode current collector.

### (C) Assembly

The manufacturing method includes assembling the battery 100 including the positive electrode 10, the negative electrode 20, an electrolyte, and the specific metal. For example, the electrode assembly 50 including the positive electrode 10, the separator 30, and the negative electrode 20 can be formed. The specific metal may be placed at such a position that the specific metal comes into contact with the positive electrode 10 when the electrode assembly 50 is assembled.

The electrode assembly 50 is housed in the case 90. The electrolyte is injected into the case 90. For example, the case 90 may be sealed at this point. The case 90 may be sealed, for example, after “(d) first charging” or after “(e) second charging.” This is because gas can be generated when charging is performed for the first time.

### (D) First Charging

The manufacturing method includes performing first charging of the battery 100. Constant voltage (CV) charging is performed in the first charging. Hereinafter, the battery voltage during CV charging is also referred to as the “CV voltage.” For example, constant current (CC) charging may be performed until the battery voltage reaches the CV voltage. That is, the first charging may include constant current-constant voltage (CCCV) charging. Hereinafter, the current during CC charging is also referred to as the “CC current.” The CC current in the first charging may be, for example, 0.1 C to 1 C, or 0.3 C to 0.7 C.

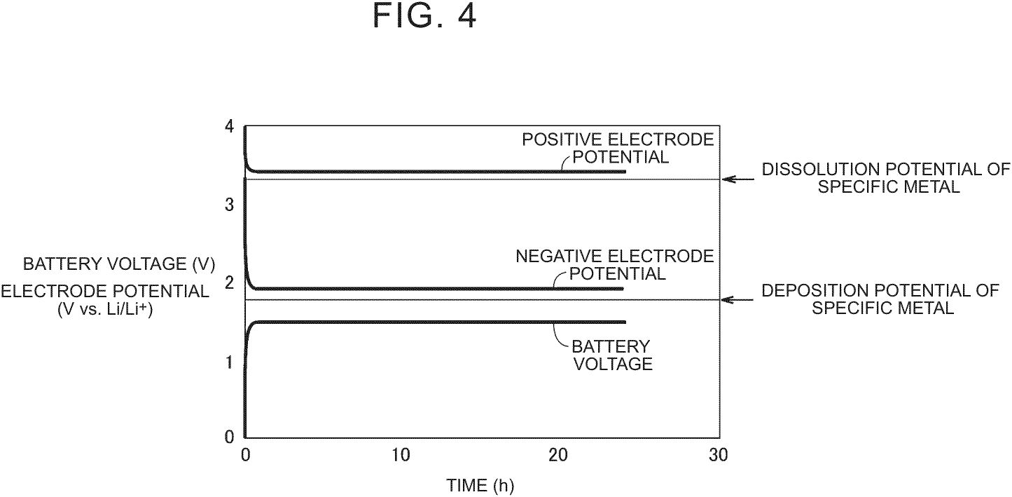

FIG. 4 is a graph showing an example of the first charging. The ordinate of the graph represents the electrode potential (Vvs. Li/Li⁺) or the battery voltage (V). The abscissa of the graph represents the charging time (h). It is herein assumed that the dissolution potential of the specific metal is 3.5 Vvs. Li/Li⁺, and the deposition potential of the specific metal is 1.9 Vvs. Li/Li⁺. For example, the CV voltage is set to 1.5 V. During CV charging, the positive electrode potential is higher than the dissolution potential (3.5 Vvs. Li/Li⁺). It is therefore considered that the specific metal that is electrically in contact with the positive electrode 10 is oxidized and dissolved. Specific metal ions are generated by the oxidation and dissolution of the specific metal. The specific metal ions are attracted to the negative electrode 20 having a low potential. During CV charging, the negative electrode potential is higher than the deposition potential (1.9 Vvs. Li / Li⁺). It is therefore considered that the specific metal ions having reached the negative electrode 20 are less likely to be deposited. It is considered that the specific metal ions can penetrate the inside (voids) of the negative electrode active material without being deposited.

The CV voltage may be, for example, 1.1 V to 1.8 V, or 1.2 V to 1.5 V.

The CV charging may be performed, for example, for one hour to 48 hours or for 8 hours to 24 hours.

The battery 100 may be heated during the first charging. Heating may, for example, facilitate diffusion of the specific metal ions. The ambient temperature during the first charging may be, for example, 40° C. to 70° C., or 55° C. to 65° C.

### (E) Second Charging

The manufacturing method includes performing second charging of the battery 100 after the first charging. In the second charging, the battery 100 is charged so that the negative electrode potential becomes equal to or lower than the deposition potential. As a result, the specific metal is deposited on the negative electrode 20. Since the specific metal ions have penetrated the inside of the negative electrode active material in the first charging, the specific metal can be deposited on both the outside and inside surfaces of the negative electrode active material.

The ambient temperature during the second charging may be, for example, room temperature (25 ± 10° C.). The second charging may include, for example, CCCV charging. The CC current may be, for example, 0.1 C to 10 C, or 0.5 C to 5 C. In the second charging, the battery 100 may be charged to, for example, the SOC of 50% to 100%, the SOC of 70% to 100%, or the SOC of 80% to 90%.

### (F) Aging

The manufacturing method may include aging after the second charging. For example, the battery 100 may be stored in a high temperature environment. The ambient temperature during aging may be, for example, 40° C. to 70° C., or 55° C. to 65° C. The storage time (aging time) may be, for example, one hour to 48 hours, or 18 hours to 24 hours.

### Manufacturing of Test Batteries

Test batteries according to No. 1 to No. 3 were manufactured in a manner described below. Hereinafter, for example, the “test battery according to No. 1” is sometimes simply referred to as “No. 1.”

### No. 1

First, “(a) preparation of positive electrode” and “(b) preparation of negative electrode” were performed (see FIG. 3). In “(c) assembly,” a test battery was assembled so that the specific metal would not get into the test battery.

Thereafter, “(e) second charging” was performed to the SOC of 90% under the following conditions.
Ambient temperature: 25° C.
Charge mode: CCCV
CC current: 5 C
Cut current: 0.2 C

After the second charging, “(f) aging” was performed under the following conditions.
Ambient temperature: 60° C.
Aging time: 22 hours

No. 1 was thus manufactured. It is considered that No. 1 does not include the specific metal. In the manufacturing process of No. 1, “(d) first charging” was not performed (see FIG. 3).

### No. 2

A small piece of SUS304 was prepared as a specific metal. SUS304 contains Fe, Cr, and Ni.

A small piece of the specific metal was placed on a surface of a positive electrode. An electrode assembly was formed after the specific metal was placed. For No. 2, “(c) assembly” was performed in the same manner as in that of No. 1 except for this.

After the test battery was assembled, “(e) second charging” and “(f) aging” were performed in a manner similar to that of No. 1. No. 2 was thus manufactured. In the manufacturing process of No. 2, “(d) first charging” was not performed (see FIG. 3).

### No. 3

A test battery including a specific metal was assembled in a manner similar to that of No. 2.

Thereafter, “(d) first charging” was performed under the following conditions.
Ambient temperature: 60° C.
Charge mode: CCCV
CC current: 0.5 C
CV voltage: 1.5 V
Cut time: 24 hours

After the first charging, “(e) second charging” and “(f) aging” were performed in a manner similar to that of No. 1 and No. 2. No. 3 was thus manufactured.

### Evaluation

The SOC of each test battery was adjusted to 10%. Each test battery was discharged by a current of 5C at an ambient temperature of 25° C. A voltage drop was measured 10 seconds after the start of the discharging. The battery resistance (DC-IR) was obtained from the current and the voltage drop.

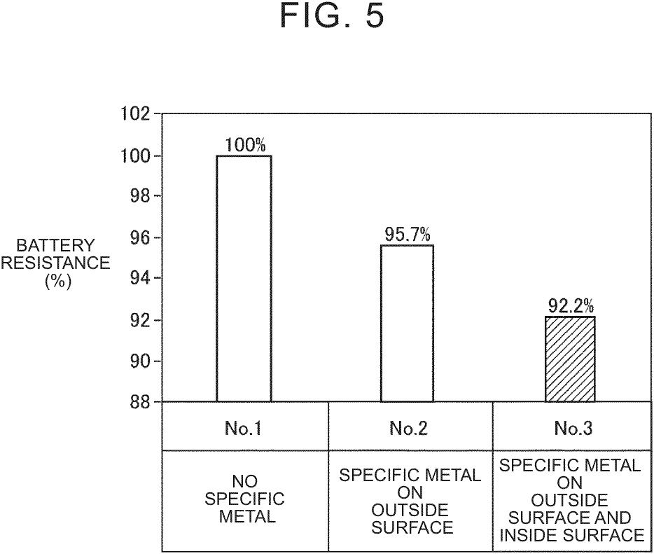

FIG. 5 is a graph showing the battery resistance. The ordinate of the graph represents the battery resistance. The battery resistances in FIG. 5 are relative values with respect to the battery resistance of No. 1 when the battery resistance of No. 1 is considered to be 100%. The battery resistance of No. 2 was reduced by 4.3% from the battery resistance of No. 1. The battery resistance of No. 3 was reduced by 7.8% from the battery resistance of No. 1.

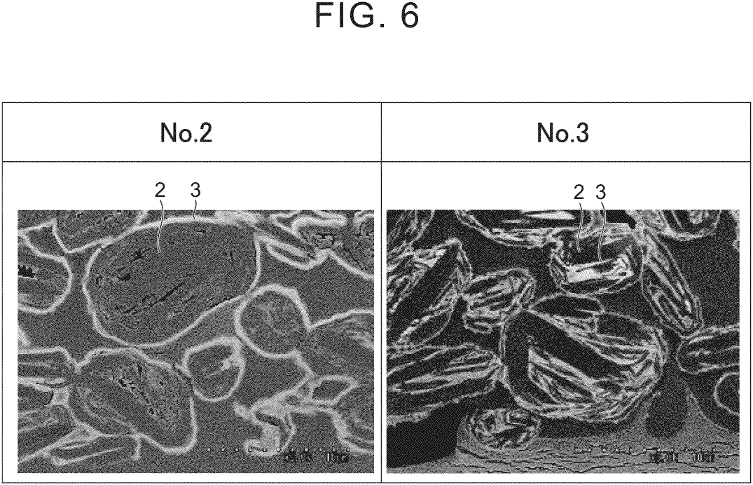

FIG. 6 shows sectional (SEM) images of the negative electrodes of No. 2 and No. 3. Differences in brightness within each image indicate differences in composition. Black portions are considered to indicate voids. Gray portions are considered to indicate the negative electrode active material 2 (graphite). White portions are considered to indicate the specific metal 3 (Fe, Cr, Ni).

In No. 2, the specific metal 3 adhered to the outside surface of the negative electrode active material 2. It is considered that, since the outside surface was covered with the specific metal 3, the SEI growth was inhibited on the outside surface and the battery resistance was reduced by 4.3%. In No. 2, the specific metal 3 did not adhere to the inside surface of the negative electrode active material 2.

In No. 3, the specific metal 3 adhered to both the outside and inside surfaces of the negative electrode active material 2. It is considered that, in No. 3, specific metal ions penetrated the inside of the negative electrode active material 2 by the first charging. It is considered that, since both the outside and inside surfaces were covered with the specific metal 3, the SEI growth was inhibited on both the outside and inside surfaces and the battery resistance was reduced by 7.8%.

The embodiment and the examples are illustrative in all respects. The embodiment and the examples are not restrictive. The technical scope of the present disclosure includes all modifications within the meaning and scope equivalent to the claims. For example, it is planned from the beginning that any desired configurations are extracted from the embodiment and the examples and combined as desired.

What is claimed is:

1. A lithium-ion battery, comprising:
a positive electrode;
a negative electrode; and
an electrolyte, wherein:
the positive electrode includes a positive electrode active material;
the negative electrode includes a negative electrode active material and a specific metal;
a void is located inside the negative electrode active material;
the specific metal adheres to an outside surface and an inside surface of the negative electrode active material;
the specific metal includes a dissolution potential and a deposition potential;
the dissolution potential is lower than a potential at which the positive electrode active material releases lithium ions; and
the deposition potential is higher than a potential at which the negative electrode active material stores the lithium ions.

2. The lithium-ion battery according to claim 1, wherein the specific metal includes at least one selected from the group consisting of potassium, rubidium, barium, strontium, calcium, sodium, magnesium, aluminum, uranium, titanium, zirconium, manganese, zinc, chromium, iron, cadmium, cobalt, nickel, tin, lead, copper, mercury, and silver.

3. The lithium-ion battery according to claim 1, wherein the specific metal includes at least one selected from the group consisting of iron, chromium, and nickel.

4. The lithium-ion battery according to claim 1, wherein a ratio of mass of the specific metal to mass of the negative electrode active material is 0.192 to 0.384.

5. The lithium-ion battery according to claim 1, wherein the negative electrode active material is a secondary particle including a plurality of primary particles, and the void is located between the primary particles.

6. The lithium-ion battery according to claim 5, wherein in the negative electrode active material, the specific metal adheres to the inside surface up to a distance of one-fifth or more of a maximum diameter of the secondary particle from a surface of the secondary particle toward a center of the secondary particle on a line segment of the maximum diameter of the secondary particle.

7. A method for manufacturing a lithium-ion battery, the method comprising:
preparing a positive electrode including a positive electrode active material;
preparing a negative electrode including a negative electrode active material;
assembling the lithium-ion battery including the positive electrode, the negative electrode, an electrolyte, and a specific metal;
performing first charging of the lithium-ion battery; and
after the first charging, performing second charging of the lithium-ion battery, wherein:
a void is located inside the negative electrode active material;
the specific metal includes a dissolution potential and a deposition potential;
the dissolution potential is lower than a potential at which the positive electrode active material releases lithium ions;
the deposition potential is higher than a potential at which the negative electrode active material stores the lithium ions;
in the assembling the lithium-ion battery, the specific metal is placed so as to be electrically in contact with the positive electrode;
the first charging includes performing constant voltage charging of the lithium-ion battery at such a battery voltage that a positive electrode potential becomes higher than the dissolution potential and a negative electrode potential becomes higher than the deposition potential; and
in the second charging, the negative electrode potential becomes equal to or lower than the deposition potential.
